(19) United States
(12) Patent Application Publication
(10) Pub. No.: US 2006/0149536 A1
(43) Pub. Date: Jul. 6, 2006

(54) SID frame update using SID prediction error

(76) Inventor: Dunling Li, Rockville, MD (US)

Correspondence Address: TEXAS INSTRUMENTS INCORPORATED, P O BOX 655474, M/S 3999, DALLAS, TX, 75265, US

(21) Appl. No.: 11/027,276

(22) Filed: Dec. 30, 2004

(51) Int. Cl. G10L 11/06

(52) U.S. Cl. 704/215

(57) ABSTRACT

In a packet-based multimedia communication system, such as ITU G.711, using linear prediction parameters to derive the linear prediction error of the codec. The linear prediction error is then used as a feature of the Silence Insertion Descriptor (SID) algorithm. Generating a SID frame by comparing linear prediction errors between frames in the input data stream to a threshold.

### CROSS-REFERENCE TO RELATED APPLICATIONS

None

### FIELD OF THE INVENTION

This invention relates to the generation of a Silence Insertion Descriptor (SID) in a multimedia communication system, such as a voice over packet (VOP) network. In particular, the preferred embodiment relates to improvement of a SID update algorithm in the International Telecommunications Union G.711 Appendix II standard and conservation of processing resources by using the linear prediction error of the codec as feature in decision to generate a SID frame.

### BACKGROUND OF THE INVENTION

Voice over packet (VOP) networks require that the voice or audio signal be packetized and then be transmitted. The analog voice signal is first converted to a digital signal and is compressed in the form of a pulse code modulated (PCM) digital stream. As illustrated in FIG. 1, the PCM stream is processed by modules of the gateway, such as an echo cancellation unit (ECU) 10, voice activity detection (VAD) 12, voice compression (CODEC) 14, protocol configuration 16, etc.

Various techniques have been developed to reduce the amount of bandwidth used in the transmission of voice packets. One of these techniques reduces the number of transmitted packets by suspending transmission during periods of silence or when only background noise is present. The International Telecommunication Union (ITU) G.711 Appendix II recommendation defines a generic comfort noise payload format for use in packet-based multimedia communications. The format may be used with other speech codecs that do not use a built-in Discontinuous Transmission (DTX) capability. G.711 Appendix II defines the use of VAD (Voice Activity Detection), DTX, and CNG (Comfort Noise Generation) in a speech communication system. These standards are provided as exemplary implementations in order to reduce the transmission rate during inactive speech periods while at the same time maintaining acceptable levels of speech quality. VAD operates to discriminate between active and inactive speech in a communication signal. The standard uses CNG to describe background noise during inactive voice signals to minimize packet transmission rates. A SID frame contains a description of the background noise that is packed into the CNG payload prior to transmission. The SID update algorithm determines when a SID frame is transmitted in the input stream to a receiver. SID (Silence Insertion Descriptor) frames can be transmitted periodically or only when there is a significant change in the background noise characteristics.

In a system where these two algorithms exist and are enabled, VAD 12 makes the “voice/no voice” selection as illustrated in FIG. 1. Either one of these two choices is the VAD algorithm's output. If voice (active) is detected, a regular voice path is followed in the CODEC 14 and the voice information is compressed into a set of parameters. If no voice (inactive) is detected, the DTX algorithm is invoked and the SID algorithm generates a SID 18 to transmit at the beginning of this interval of silence. Aside from the first transmitted SID 18, during a current inactive period, the SID update algorithm analyzes the background noise changes.

In case of a background noise change, the SID update algorithm generates a SID packet 18. If no change is detected, the algorithm does not generate a SID. Generally, SID packets contain a signature of the background noise information 20 with a minimal number of bits in order to utilize limited network resources. On the receiving side, for each frame, the decoder reconstructs a voice or a noise signal depending on the received information. If the received information contains voice parameters, the decoder reconstructs a voice signal. If the decoder receives no information, it generates noise with noise parameters embedded in the previously received SID packet. This process is called Comfort Noise Generation (CNG). If the decoder is muted during the silent period, there will be sudden drops of the signal energy level, which causes unpleasant conversation. Therefore, CNG is essential to mimic the background noise on the transmitting side. If the decoder receives a new SID packet, it updates its noise parameters for the current and future CNG until the next SID is received.

The SID update algorithm determines how often SID transmissions occur during periods of inactive speech during a packet transmission. Basic SID update algorithms update periodically, but the more complex generate a SID only after analyzing the signal and detecting a significant” change in background noise character. When the signal is being coded, the estimated parameters of background noise energy and spectral content are updated. In the case of a SID, the estimated background noise energy and spectral content parameters are quantized and formatted for transmission in the communication stream to a receiver.

The standard does not specify a specific method or algorithm to determine when SID transmission should occur or how to update the SID update algorithm. Problems with the general approaches in the standard is that the SID update algorithm in the standard are twofold. First, if the SID algorithm transmits a SID periodically, there is a great chance that too many SID frames will be transmitted to a receiver. For example, if the length of periodicity is set too small, too many SIDs may be transmitted unnecessarily when background noise does not vary significantly, which is contrary to the goal of decreasing bandwidth by replacing inactive voice signals with a SID.

Since SIDs have considerably fewer payload bits than voice packets, generating many SID packets should theoretically not create bandwidth problems. However, this is not always the case. FIG. 2 illustrates an example of a packet format in a packet-based communication network. Since both voice and SID packets 22 must have packet headers 24 in VOP applications, bandwidth is still affected by the necessary formatting protocols of the packets. The header length is the same for voice and SID packets. Sometimes the header 24 occupies most of the bandwidth in a SID packet 22. Therefore, it is very important for bandwidth savings to reduce the number of SID packets while preserving sound quality.

The second problem is how to efficiently update the SID algorithm in G.711 Appendix II without consuming many additional MIPS (millions of instructions per second) of processing resources or memory resources. What is needed is a method to update the SID algorithm using data that is already available in the comfort noise generation methods recommended in the standard.

### SUMMARY OF THE INVENTION

To overcome the disadvantages and problems of the prior art, the preferred embodiment uses a novel method of generating a SID (Silence Insertion Descriptor) by using the linear prediction parameters that are already generated as part of an ITU G.711 Appendix II implementation. The method analyzes the difference of the linear prediction error from a current and previous frame during periods of background noise and compares the difference to a threshold. Based on these calculations, the decision is made to generate a SID as the current frame in an input packet stream.

Since parameters that are used in G.711 Appendix II implementations are used as a basis for SID generation, a savings in both MIPS (millions of instructions per second) processing resources and memory resources is realized. The present invention for generating SID frames can be implemented for G.711 Appendix II and other applications for multimedia communications.

### BRIEF DESCRIPTION OF THE DRAWINGS

For a better understanding of the nature of the present invention, its features and advantages, the subsequent detailed description is presented in connection with accompanying drawings in which:

FIG. 1 is a functional block diagram illustrating the separate processing paths for voice, tone, and silence;

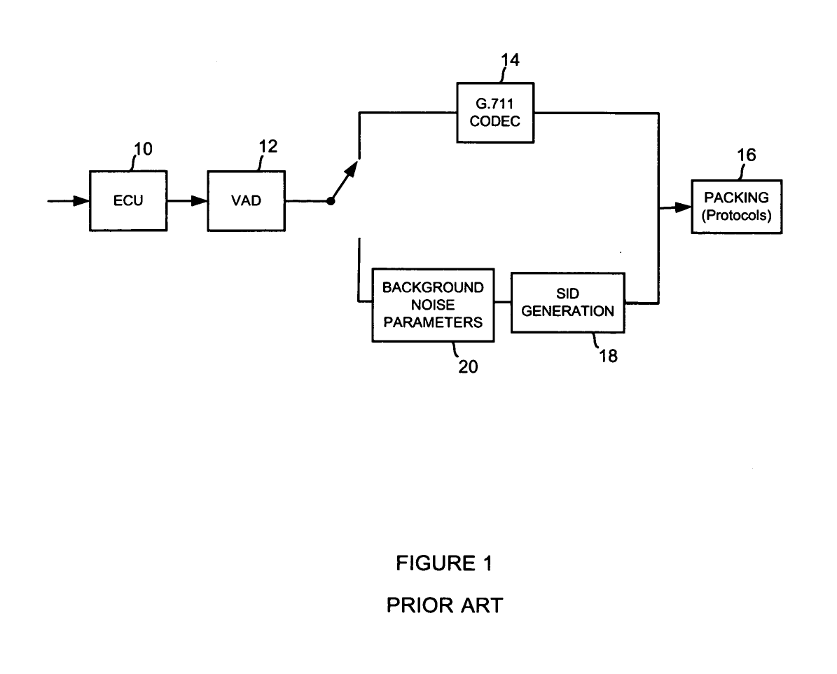

FIG. 2 is a diagram illustrating a typical packet;

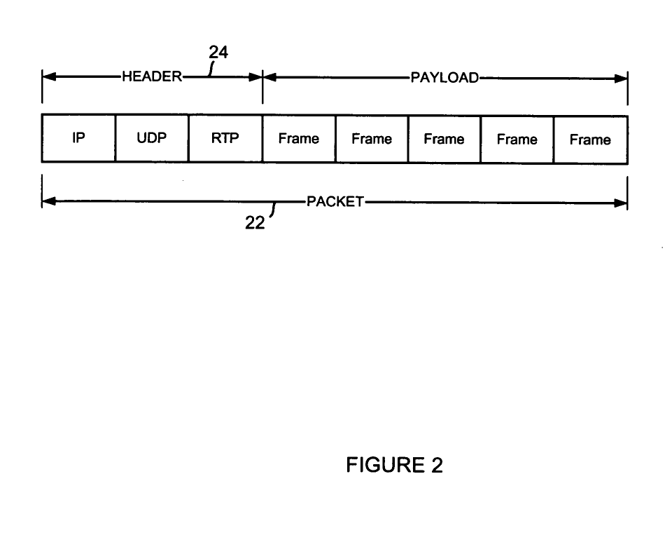

FIG. 3 is a functional flow diagram of the preferred embodiment.

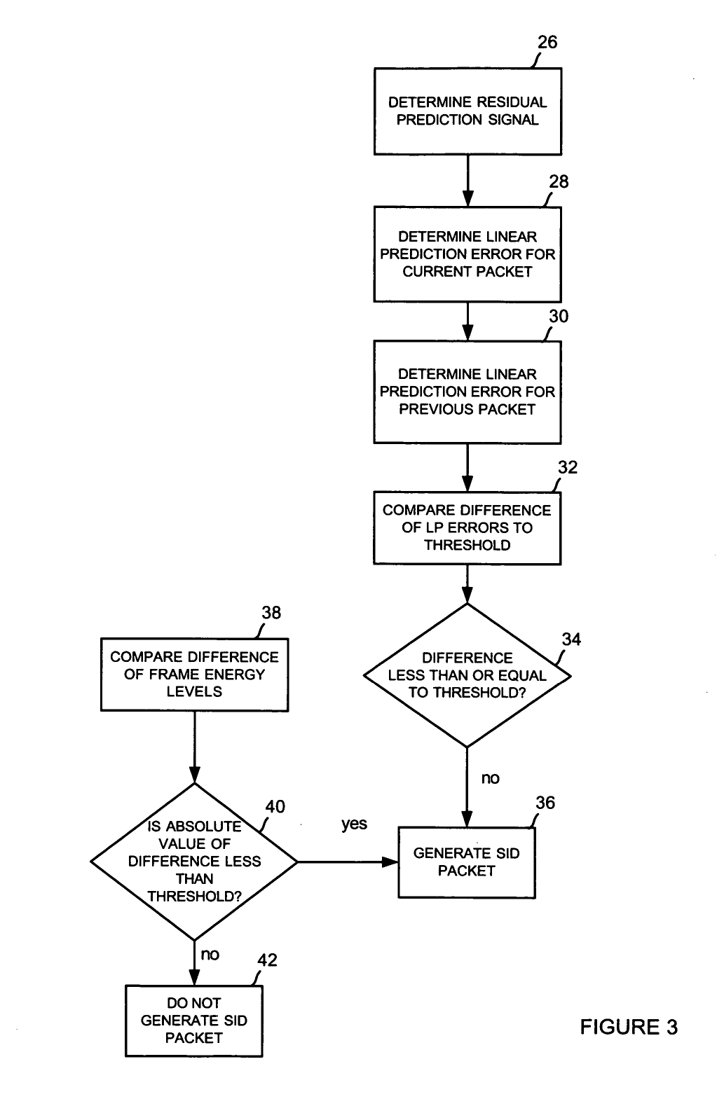

### DETAILED DESCRIPTION OF THE INVENTION

The preferred embodiment includes a technique and system to update a SID (Silence Insertion Descriptor) frame algorithm in a packet-based multimedia communication system. The decision to send a SID packet is based on the prediction residual of the spectral content of the background noise. This technique uses calculations of linear error predictions of the codec between consecutive input frames that are compared to a threshold. One implementation of the present invention includes the ITU G.711 Appendix II standard, which specifies that a DTX (Discontinuous Transmission) algorithm (also called the “SID update algorithm”) “determines the frequency of SID frame transmission” and that more complex algorithms can also transmit a SID using a SID update algorithm that determines “when a significant change in background noise character is detected” during a period of inactive speech.

In a digital communication system, such as the G.711 Appendix II standard, a CNG (Comfort Noise Generation) function can be used to describe and reproduce the background noise according to energy and spectral shapes of each frame in the input stream. The spectral shapes of the background noise of a current packet in the input packet stream can be represented with linear prediction (LP) parameters. Because these parameters are known for each frame, an LP prediction error can be determined and used in the preferred embodiment as a feature of the SID update algorithm.

The preferred embodiment of the present invention uses the linear prediction error to determine whether the current frame in the input flow stream should be a SID frame. A linear prediction error is also defined as a linear prediction residual. This is implemented 26 by first determining the residual prediction signal in the input packet stream. An exemplary calculation for linear prediction error is as follows.

In the following equations, let a(i), i=0, 1, . . . , M represent the coefficients of a linear prediction filter A(z). Let x(i), i=1, 2, . . . , f_{size} (e.g., frame size) represent the input samples of the current frame under analysis. The residual signal y(n) is then calculated as follows:

$$y ( n ) = {\sum }_{i = 0}^{M} {a}_{i} x ( n - i ) = x ( n ) - {\sum }_{i = 1}^{M} {a}_{i} x ( n - i )$$

After calculating the residual signal y(n), the prediction error for y(n) is determined 28 using the following calculation. This calculation includes summing the input samples up to the current frame for the square of the residual signal. In the calculation, R(0) is the auto-correlation of the energy of the current input sample and Rxx represents the cross-correlation for further samples.

$$\begin{matrix}Err ( x , a ) = {\sum }_{n = 1}^{fsize} {y ( n )}^{2} \\ = {\sum }_{n = 1}^{fsize} {( x ( n ) - {\sum }_{i = 0}^{M} {a}_{i} x ( n - i ) )}^{2} \\ = {\sum }_{n = 1}^{fsize} \text{(} {x ( n )}^{2} - 2 x ( n ) {\sum }_{i = 0}^{M} {a}_{i} x ( n - i ) + {\sum }_{i = 0}^{M} {\sum }_{j = 0}^{M} {a}_{i} {a}_{j} x ( n - i ) x ( n - j ) \\ = {\sum }_{n = 1}^{fsize} \text{(} {x ( n )}^{2} - 2 {\sum }_{i = 0}^{M} {a}_{i} {\sum }_{n = 1}^{fsize} x ( n ) x ( n - i ) + \\ {\sum }_{i = 0}^{M} {\sum }_{j = 0}^{M} {a}_{i} {a}_{j} {\sum }_{n = 1}^{fsize} x ( n - i ) x ( n - j ) \\ = {\sum }_{n = 1}^{fsize} \text{(} {x ( n )}^{2} - 2 {\sum }_{i = 0}^{M} {a}_{i} R ( 0 , i ) + {\sum }_{i = 0}^{M} {\sum }_{j = 0}^{M} {a}_{i} {a}_{j} R ( i , j )\end{matrix}$$

$$Where$$

$$R ( i , j ) = {\sum }_{n = 1}^{fsize} x ( n - i ) x ( n - j )$$

The next step 30 is to calculate the linear prediction error from the previous frame's LP parameters. This LP error is calculated as

$$Err ( x , a\_sid ) = {\sum }_{n = 1}^{fsize} {x ( n )}^{2} - 2 {\sum }_{i = 0}^{M} {a\_sid}_{i} R ( 0 , i ) + {\sum }_{i = 0}^{M} {\sum }_{j = 0}^{M} {a\_sid}_{i} {a\_sid}_{j} R ( i , j )$$

After determining the prior frame's LP error, the next step is to determine the LP error from the current frame in the input transmission. The prediction error from the current LP parameters is determined from the following formula:

$$Err ( x , a ) = {\sum }_{n = 1}^{fsize} {x ( n )}^{2} - 2 {\sum }_{i = 0}^{M} {a}_{i} R ( 0 , i ) + {\sum }_{i = 0}^{M} {\sum }_{j = 0}^{M} {a}_{i} {a}_{j} R ( i , j )$$

Using the LP error from the current frame and the previous frame's LP error, the decision of whether to generate a SID can be determined. The embodiment preferably determines difference between the LP error of the current and previous frames and compares this difference to a threshold Th_err 32, as follows:
Err(x, a_sid)−Err(x, a)>Th_err
If the difference is greater than the threshold level 34, then the current frame is transmitted as a SID 36. Some exemplary thresholds are listed below. However, it is understood that these are merely exemplary implementations of the preferred embodiment and can vary depending upon specific system implementations and networks.

$$Th\_err = \{ \begin{matrix}1 dB = 1.2589 & a = f ( r ) \\ 0.9 dB = 1.2303 & a = f ( rm )\end{matrix}$$

In an alternative exemplary embodiment, the determination of whether to generate a SID frame is based upon a calculation of a current frame energy and the energy of the previously generated SID frame. If the difference in LP errors, calculated above, is less than or equal to the threshold, then a comparison to the energy levels of the current and previous frames can be made 38. In the alternative embodiment, the absolute value of the difference between the current frame energy and the energy of the previous frame is compared to a threshold energy level Th_E, as follows:
|R(0)−E_sid|>Th_{—}E
If the absolute value is less than the threshold 40, then the current frame will be transmitted as a SID 36. If the absolute value of the difference is not less than the threshold, then no SID is generated 42. An exemplary threshold determination is Th_E=3 dB. However, it is understood that this is merely an exemplary implementation of the alternative exemplary embodiment and can vary depending upon specific system implementations and networks.

The SID update algorithm can preferably change between using the method for comparing LP errors with Th_err and using the alternative method for comparing energy levels with Th_E. A change can be based on a given SID frame rate in order to transmit a SID frame for the given frame rate in a case of relative steady noise, and for cases where background noise changes are extremely large a change can update the SID frame more often.

Using the preferred embodiment, SID frames are generated using linear prediction errors that can be determined with minimal MIPS processing resources and minimal memory. Thus, an efficient, accurate method for generating SID frames can be implemented for G.711 Appendix II and other applications for multimedia communications.

One skilled in the art will appreciate that the present invention can be practiced by other than the described embodiments, which are presented for purposes of illustration and not limitation, and the present invention is limited only by the claims that follow.

What is claimed is:

1. A method to determine silence insertion descriptor (SID) generation in a multimedia communication system, comprising:
calculating a first linear prediction error from a current frame of input samples in a digital multimedia communication system;
calculating a second linear prediction error from a prior SID frame of said input samples in said system;
determining a difference between said second linear prediction error and said first linear prediction error; and
generating a SID frame as the current frame based on said difference.

2. The method of claim 1, wherein said generating comprises generating said SID frame if the determined difference exceeds a threshold.

3. The method of claim 1, wherein said calculating said first linear prediction error and said calculating said second linear prediction error comprises calculating said first and said second linear prediction errors in a communication system implementing an International Telecommunication Union (ITU) G.711 Appendix II recommendation.

4. The method of claim 1, wherein said calculating said first linear prediction error in said current frame comprises calculating a residual signal from said current frame, and
calculating said first linear prediction error from said residual signal.

5. The method of claim 1, wherein said calculating said first linear prediction error in said digital multimedia communication system comprises calculating said error in a packet-based multimedia communication system operating according to ITU G.711 recommendations.

6. A method to determine silence insertion descriptor (SID) generation in a multimedia communication system, comprising:
calculating a first linear prediction error from a current frame of input samples in a digital multimedia communication system;
calculating a second linear prediction error from a prior frame of said input samples in said system;
determining that a difference between said second linear prediction error and said first linear prediction error is equal to or less than a threshold; and
generating a SID frame based on a first background energy level of said current frame and a second background energy level of said prior frame.

7. The method of claim 6, wherein said generating said SID frame comprises generating said SID frame when an absolute value of a difference of said first background energy level of said previous frame and said second background energy level of said current frame is above a threshold.

8. The method of claim 6, wherein said calculating said first linear prediction error and said calculating said second linear prediction error comprises calculating said first and said second linear prediction errors in a communication system implementing an International Telecommunication Union (ITU) G.711 Appendix II recommendation.

9. The method of claim 6, wherein said calculating said first linear prediction error in said current frame comprises calculating a residual signal from said current frame, and
calculating said first linear prediction error from said residual signal.

10. The method of claim 6, wherein said calculating said first linear prediction error in said digital multimedia communication system comprises calculating said error in a packet-based multimedia communication system operating according to ITU G.711 recommendations.
